(19) United States
(12) Patent Application Publication
(10) Pub. No.: US 2021/0345787 A1
(43) Pub. Date: Nov. 11, 2021

(54) Inflatable Coveralls Transforms into a Chair to Lift a Fallen Person

(71) Applicants: Akanksha Aggarwal, Windsor (CA); Anish Aggarwal, Windsor (CA); Aditya Akshai kumar Aggarwal, Windsor (CA)

(72) Inventors: Akanksha Aggarwal, Windsor (CA); Anish Aggarwal, Windsor (CA); Aditya Akshai kumar Aggarwal, Windsor (CA)

(73) Assignee: Aditya Aggarwal, Detroit, MI (US)

(21) Appl. No.: 16/550,268

(22) Filed: Aug. 25, 2019

(51) Int. Cl. A47C 13/00; A44B 18/00; A47C 4/54; A41D 13/02; A41D 31/102

(52) U.S. Cl. CPC A47C 13/00; A44B 18/00; A44D 2203/00; A41D 13/02; A41D 31/102; A47C 4/54

(57) ABSTRACT

Inflatable coveralls provide individuals, who fall frequently, with protection and independence. The coveralls consist of pads on the shoulders and hips to reduce the impact of a fall on the person. When worn and located underneath the fallen person, the coveralls can be inflated with air into a chair, creating a higher platform from which the person can more easily get up. This reduces the dependence these individuals have on a care-giver. Users can fasten the coveralls using velcros, instead of buttons or zippers, because it is easier to wear and they automatically open from the increase in air pressure of the inflated coveralls. Made of light-weight and air impermeable material, the inflatable coveralls pads the fall of individuals, and elevated the fallen individual so that they can more easily rise, allowing them to gain independence.

### CROSS-REFERENCE TO RELATED APPLICATIONS

UK Patent Application No #0112568,1 ‘Lifting Seat apparatus suitable for use in a bath’—A lifting seat apparatus suitable for raising and lowering a person in a bath comprises a seat element and a backrest or lumber support element which are formed as an integral inflatable structure.

This structure comprises two inflatables portions connected together by a joint which is flexible when the structure is deflated but becomes semi-rigid when the structure is inflated.

The structure is supported by a stack of inflatable bags which are inflated and deflated to raise and lower the structure

U.S. Pat. No. 6,161,902—STABILIZED INFLATABLE CHAIR—An inflatable chair having a Seat with front, rear, top, bottom and opposite Side portions, a back at the rear of the Seat, a pair of armrests at the Sides of the Seat, the Seat, back and armrests defining inflatable first air chambers, a first valve for inflating the first air chambers, the bottom having front, rear and opposite Side parts the chair further including generally tubular inflatable Second air chambers at the front and rear and Side parts respectively of the Seat, and a Second Valve for inflating the Second air chambers independently of the first air chambers for providing a Stabilizing Support to resist tipping of said chair.

### STATEMENT REGARDING FEDERALLY SPONSORED RESEARCH

Not Applicable

### THE NAMES OF THE PARTIES TO A JOINT RESEARCH AGREEMENT

1. Akanksha Aggarwal, US Citizen
2. Anish Aggarwal, US Citizen
3. Adityakumar Akshaikumar Aggarwal, US Citizen

### STATEMENT REGARDING PRIOR DISCLOSURES BY THE INVENTOR OR A JOINT INVENTOR

Not Applicable

### BACKGROUND OF THE INVENTION

One of the health issues for the seniors or patients suffering from muscular dystrophy, such as Kennedy Disease Syndrome (also known as Bulbo-Spinal Muscular Atrophy), is frequent falls.

These persons are not able to get up from the floor, after a fall, by themselves due to weakness of their muscles. Such persons can have more than one fall during a week.

These falls prevent them from living by themselves.

They need another person, who can take care of them, if they fall down.

There are extreme cases where seniors in cold countries have stepped out of their house to put garbage in front of the house, slipped, failed to get up and frozen to death.

This invention tries to address the issue of helping seniors or people with muscular dystrophy to get up on their own, if they are not severely injured.

A number of commercial products are available to help persons, who are prone to falling, to get up from floor.

But all of the products require a care-giver to bring the lifting device to the person, who has fallen, and to help the person get up.

The care-giver is required to be with such a person all the time since there is very little advance warning about when a person, who is prone to fall, will fall.

It can happen, at any time, at home or in a park or in a parking lot or at a friend's place or in a mall or at any other place.

The Raizer is a simple battery-operated mobile lifting chair that helps a fallen person up to an almost standing position within a few minutes.

Raizer can be assembled with ease.

It can be operated by only one assistant and does not require any physical effort besides a supportive hand.

The Camel Lifting Chair is designed to easily lift a fallen person. With an inbuilt backrest and internal ring construction, the Camel offers a fully supportive lift.

Using the simple hand control and compressor, which is a part of the Camel Lifting Chair, the camel is inflated.

The Camel can be used anywhere, indoors or outside, and will lift a fallen person with dignity, while protecting both the care-giver and the person being lifted from injury.

There are a number of different industrial Hydraulic lifts for medical use for lifting persons, who are prone to fall and who cannot get up on their own, from the ground.

However, all of these lifts need care-givers to bring the lift to the person, who has fallen, to lift them from the ground.

### FIELD OF THE INVENTION

### A61G 7/10

### A61G 7/1011

### A61G 7/1021

### DESCRIPTION OF RELATED ART

U.S. Pat. No. 5,500,952A Hip inflatable protection device—The invention is a self-contained protective device/system designed to protect the hips, pelvis, buttocks, and coccyx areas of the user.

The device may be worn outside of the clothing.

Because it is small in size and lightweight, it may be easily put on and removed and does not interfere with body movements.

It contains the following components: an inflatable air bag folded into pleats, a battery, a gas cartridge, sensors to determine angular motion and acceleration, a triggering/valve mechanism to release the gas and a relief valve.

When the user falls, the sensors automatically release gas from the cartridge and inflate the airbag assembly, forcing the folded pleats to fully cover said areas of the user's body.

After use, the relief valve is opened to release air from the airbag assembly, the pleats are reinserted into the system and the invention is ready for reuse after the spent cartridge is replaced.

U.S. Pat. No. 4,059,852A Inflatable suit for cyclists A protective garment for minimizing impact-caused injury, primarily to the body of a motorcyclist, comprising a body-part-enclosing covering means including an effectively hollow body-part-contoured inflatable bag provided with ingress port means and exterior inflating tube means communicating the ingress port means and pressurized gas supply means and the normally closed ingress valve means relative to fixed portions of a motorcycle for forcible opening actuation of the normally closed ingress valve means upon forced abrupt separation of a motorcyclist's body from a motorcycle as a result of an accident, for causing the rapid discharge of compressed gas through the open ingress valve means, inflating tube means, and ingress port means into the inflatable bag whereby to bring about abrupt inflation thereof in a body-protecting manner.

In a preferred form, the inflating tube means is provided with controllably manually engageable and dis-engageable coupling means for allowing selective mounting and dismounting of a motorcyclist relative to a motorcycle without causing forced opening of the ingress valve means and the consequent abrupt inflation of the inflatable bag.

U.S. Pat. No. 3,895,396A Expandable protective device A lightweight multi-cell sheet like protective device that in a preferred embodiment is worn in a compact rolled donut shaped configuration about the waist of the user and is so maintained by spring means that form a part of the device.

Manually operable compressed gas or air supply means are also included as a part of the device.

Upon an emergency arising, the supply means are manually actuated to inflate the cells, with the device then inflating from the first position to cover all or a desired portion of the user's body to protect the user from a sudden shock or other changes of the environment that would be detrimental to him.

### BRIEF SUMMARY OF THE INVENTION

This invention is an inflatable coveralls, formed of light-weight air-impermeable material and attached to inflating devices to transform the coveralls into a chair.

The design of the inflatable coveralls is made up of one or more chambers to form the seat, backrest, and armrest—to help raise persons who have fallen and struggle to get up on their own.

This air-impermeable material is covered by fabric which is comfortable to wear.

Coveralls are fastened through velcros or magnets.

This facilitates the user to wear the coveralls easily as compared with a coveralls with buttons and hooks.

Secondly, the velcros or magnets are unfastened due to air pressure, when coveralls are inflated.

The coveralls have pads around the hips and shoulders to reduce the impact of a fall on the person.

Inflation mechanisms will be placed at the ankles, where there is minimal impact upon falls.

Inflation mechanisms can either use air pumps in one embodiment or use compressed air canisters, or use chemicals, which produce gas when a chemical reaction is triggered.

The technique of using chemicals for producing gas is also used in airbags in vehicles.

The inflation mechanism can be controlled manually by the person, who has fallen.

Or the mechanism can be integrated with smart watches or voice recognition system.

The mechanism can also be designed to start when a person is falling by embedding directional-fall sensors in the coveralls.

Once the chair is inflated, coveralls will open up, allowing the person, who has fallen, to independently get up from the higher surface of chair, created by air-ingress into the chambers, built in the coveralls.

### BRIEF DESCRIPTION OF THE SEVERAL VIEWS OF THE DRAWINGS

FIG. 1 is the front view of the coveralls, which will be placed on the back of the person.

FIG. 2 is similar to FIG. 1, demonstrating how the coverall will be placed on the person, along with how the coveralls will fold into wearable clothing.

FIG. 3(a) is the right-side view of the inflated coverall as a chair.

FIG. 4(a) is the front view of the inflated coverall as a chair.

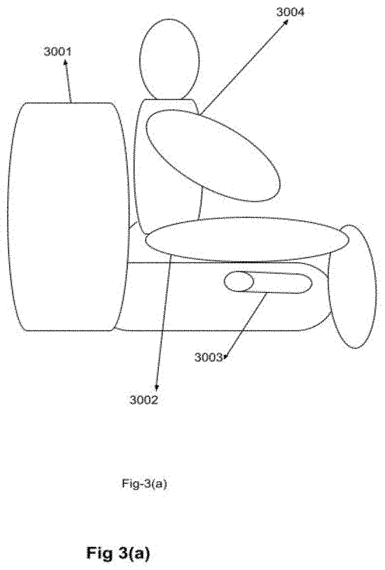

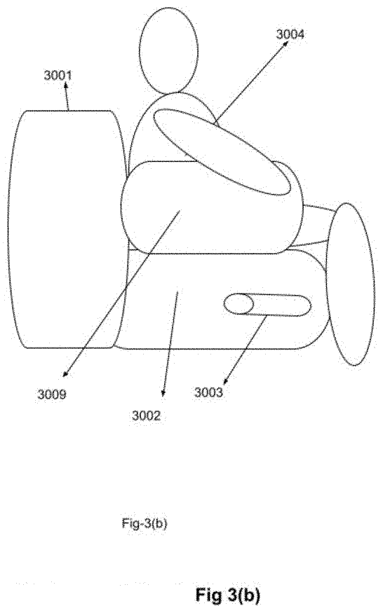

FIG. 3(b) is the right-side view of the inflated coverall as a chair with arm rest.

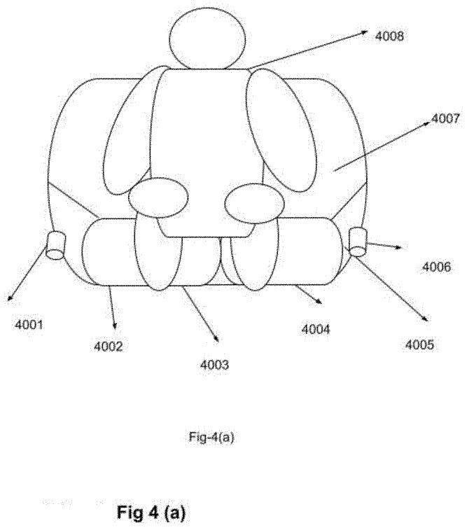

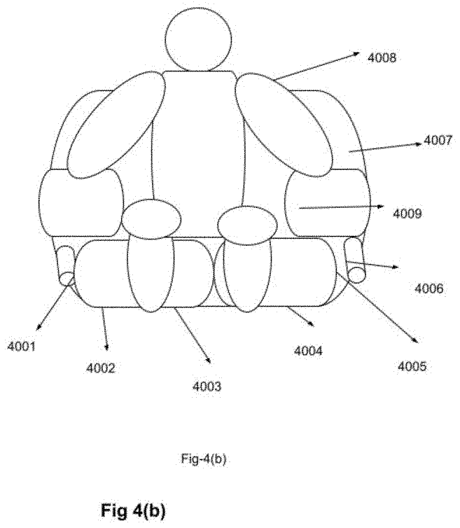

FIG. 4(b) is the front view of the inflated coverall as a chair with arm rest.

### DETAILED DESCRIPTION OF THE INVENTION

An inflatable coveralls is designed for use of seniors or persons, who frequently fall down and struggle to get up from the floor.

If such a person is wearing the coveralls when they fall, the mechanism embedded in the coveralls, helps them to get up on their own, without the help of a care-giver.

The inflatable coveralls has one or more air chambers, built by using light-weight flexible air-impermeable material.

It includes one or more devices to inflate the coveralls into a chair from which the person, who has fallen can get up easily.

To reduce the impact of fall, the coveralls has pads at hip and shoulder areas.

The coveralls are expected to be worn regularly by persons, who are prone to fall.

To facilitate easier wearing, the coveralls use velcros as fasteners, instead of buttons or zippers.

Secondly the velcros make it possible to open the coveralls when the coveralls is inflated, after the person, who is wearing the coveralls, has fallen.

To make the coveralls comfortable for the wearer, the outer shell can be made of breathable material like cotton for indoor use.

For outdoor use in rain, it may have an outer layer of water-proof material.

For use when it is snowing, the outer layer may be of an appropriate material, which can keep the body of the wearer warm.

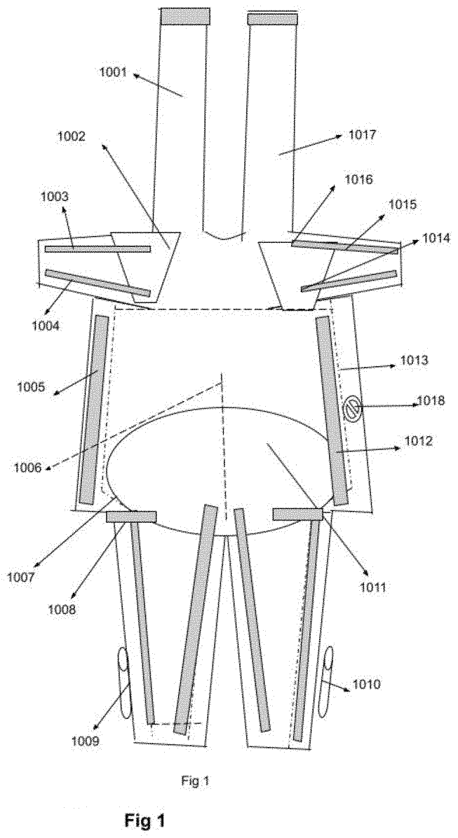

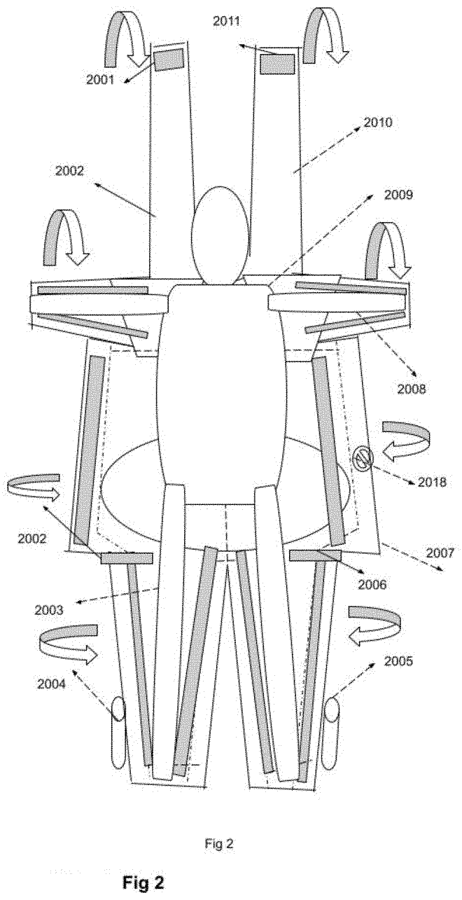

The coveralls as seen in FIGS. 1 and 2, are made of air-impermeable light-weight material which is covered in comfortable wearable fabric to support daily use.

Coveralls has pads on the shoulders 1002 and 1010 and hips 1011 to reduce the impact upon hitting the ground.

In addition, coveralls use velcros or magnets, 1003, 1004, 1005, 1008, 1012, 1014, and 1015 so that a senior or a patient can easily fasten the coveralls, without any assistance.

Velcro and magnets are easy to unfasten when the coveralls are inflated.

The coveralls can be designed to start inflating even as the person starts falling.

This will provide a cushion for reducing the adverse impact of the fall on the wearer of the coveralls.

The wearer of the coveralls, who has fallen, needs to quickly rotate themself into the supine position, so that they are lying on their back.

The person manually activates, by pressing button 1018 & 2018, the small light weight battery powered pumps, compressed air canisters or a high-speed chemical reaction.

Inflation mechanisms are placed at the ankles, 1009, 1010, 2004, 2005, 3003, 4001 and 4006 to inflate the coverall into the shape of a chair.

The chair will have one or more chambers 3001, 3002, 4002, 4005 and 4007, which can be filled with air to raise the individual 3004 and 4008, in one embodiment, to balance the individual on the chair, which has inflated arm rests.

On inflation the coveralls get transformed into chair as it lifts the wearer up from the floor.

Once coveralls is inflated into chair, the person gets up from the chair.

The chair can be deflated and worn back as coveralls.

The inflation devices can be removed from the coveralls for cleaning of coveralls or for other reasons such as putting on other coveralls or for charging of batteries.

The outer shell of the coveralls can be made of various materials depending on its use e.g. woolen material for winter coat, cotton fabric for summer weather and weather resistance material for snow and rain.

In another embodiment, the triggering of the pump will be integrated, through sensors for detecting a fall and its direction, with smart watches to automatically recognize falls and to start inflating.

This will reduce the impact, as well as contacts with the local emergency departments.

Coveralls inflation system can be integrated with cell phones or smart devices using lot devices and then can be voice enabled to allow automatic connection to 911 or emergency contacts or services.

The coveralls is designed to help the elderly to live independently and to get up after a fall, on their own.

Another embodiment of the invention is to use large balloons instead of light-weight air-impermeable material.

The advantage of this method is that as balloons deflate into smaller size, the coveralls could be completely breathable and more comfortable in wear.

The number of balloons used will depend on the size of the coveralls and size of the balloons.

A flexible tube will be used to connect all the balloons.

The disadvantage is that a more powerful mechanism will be needed to push air in the balloons and to inflate coveralls into a chair.

Although the present invention has been described in conjunction with one preferred embodiment, it is to be understood modifications and variations may be resorted to without departing from the spirit and the scope of the invention, as those skilled in the art will readily understand.

1. A wearable and inflatable coveralls comprising
(i) velcros as fasteners, instead of buttons or zippers, to makes it easy for a person to wear and to facilitate opening the coveralls when the coveralls is inflated,
(ii) pads at hip and shoulder areas to reduce impact of fall,
(iii) one or more air chambers built of light-weight flexible air-impermeable material,
(iv) devices to inflate the coveralls into a chair to enable the wearer to get up from the chair, without the assistance of another person,
(v) a switch for manually triggering the inflation mechanism,
whereby the inflatable coveralls helps raise persons who have fallen and who struggle to get up on their own.

2. The devices to inflate the coveralls according to claim 1 can be light weight battery-powered air pumps to inflate the coveralls to a chair.

3. The devices to inflate the coveralls according to claim 1 can be light weight canisters of compressed air to inflate the coveralls to a chair.

4. The devices to inflate the coveralls according to claim 1 can be gas-generating systems through high-speed chemical reaction, similar to the systems used for inflating airbags in automobiles, to inflate the coveralls to a chair.

5. The devices to inflate the coveralls according to claim 1 can be automatically triggered by a smart mobile phone or a smart watch, through sensors, which can detect a fall of the person.

6. The devices to inflate the coveralls according to claim 1 can be triggered by a voice recognition system.

7. The inflatable coveralls arms according to claim 1 can be inflated into arms rests of the chair.

8. The outer shell of inflatable coveralls according to claim 1 is made of breathable material like cotton.

9. The inflatable coveralls according to claim 8 has an outer-most sheath, can be made of water-proof material for outdoor use during rains.

10. The inflatable coveralls according to claim 8 has an outer-most sheath, can be made of material for outdoor use during winter for keeping the body warm.

11. The inner shell of inflatable coveralls according to claim 1 can be made of air-impermeable material such as thin plastic or balloons connected by flexible air pipes.

12. The inflatable coveralls according to claim 1 can use magnets as fasteners instead of Velcro.

13. A method for using an inflatable coveralls, comprises
(a) putting on inflatable coveralls as a daily wear by a person by using velcros to button up the coveralls and attaching inflatable devices to the coveralls,
(b) removing inflatable devices from the coveralls for washing or for dry cleaning,
(c) in case of a fall of the person, who is wearing the coveralls, triggering, manually or through voice activation or automatically through sensors, the inflation devices to inflate the coveralls into a chair, enabling the person to get up on their own, taking out the coveralls or deflating the coveralls and wearing the coveralls back, after the person has got up after the fall.
